(19) United States
(12) Patent Application Publication
(10) Pub. No.: US 2012/0118437 A1
(43) Pub. Date: May 17, 2012

(54) Zinc coated steel with inorganic overlay for hot forming

(76) Inventors: Jian Wang, Murrysville, PA (US); Robert W. Hyland, JR., Pittsburgh, PA (US)

(21) Appl. No.: 13/317,819

(22) Filed: Oct. 31, 2011

Related U.S. Application Data
(60) Provisional application No. 61/414,655, filed on Nov. 17, 2010.

(51) Int. Cl. B05D 3/00; C21D 6/00

(52) U.S. Cl. 148/512; 427/321

(57) ABSTRACT

The present invention is of zinc or zinc alloy coated steel for hot forming having an inorganic overlay covering the zinc or zinc alloy coating to prevent loss of zinc during heating and hot forming. In one embodiment, the inorganic overlay has a coefficient of thermal expansion greater than the coefficient of thermal expansion of zinc oxide. In another embodiment, the inorganic overlay has a compositional gradient interface with the zinc or zinc alloy coating. Preferably the inorganic overlay may be comprised of material selected from phosphates, oxides, nitrates, carbonates, silicate, chromate, molybdate, tungstate, vanadate, titanate, borate, fluoride and mixtures thereof. A method of preparing the steel for hot forming and a method for hot forming the steel are provided.

### CROSS REFERENCE TO RELATED APPLICATIONS

This application claims the benefit of U.S. Provisional Application 61/414,655 filed Nov. 17, 2010.

### TECHNICAL FIELD

This invention relates to zinc or zinc alloy coated steel for hot forming, and particularly to zinc or zinc alloy coated steel having a specific class of inorganic overlay for preventing loss of zinc at elevated temperatures during heating before hot forming is performed. The inorganic overlay in one embodiment of the present invention has a coefficient of thermal expansion greater than the coefficient of thermal expansion of zinc oxide, and in another embodiment it has a compositional gradient interface with the zinc or zinc alloy coating. The invention includes a method for making steel for hot forming having the inorganic overlay of this invention and a method for hot forming steel having the inorganic overlay.

### BACKGROUND OF THE INVENTION

Recently government standards have increased the requirements of gas mileage for the automotive industry as described in the Average Fuel Economy Standards, Passenger Cars and Light Trucks, MY 2011 (Final Rule) by National Highway Traffic Safety Administration, U. S. Department of Transportation. To comply with these requirements, automobile manufacturers seek to decrease the weight of steel parts used in the production of cars and light trucks. A decrease in weight may be achieved by reducing the thickness of the parts. In order to maintain a strong structure and provide sufficient crash worthiness the strength of the steel must be increased to compensate for the reduction in thickness. However, ultrahigh strength steels pose a major challenge in processing parts with complex shape due to their limited formability and pronounced springback tendency. Conventional stamping at room temperature only allows the production of parts with simple shapes and up to 1200 MPa tensile strength. Stamping ultrahigh-strength material requires substantial capital investment in high-tonnage mechanical presses, and material-related press options such as cutting impact dampers, resulting in high production costs. Furthermore, it is difficult to form complex parts such as A and B pillars, transmission tunnels, cross members and bumpers from advanced high strength steels (AHSS) and ultrahigh strength steels (UHSS) without multi-step processes using progressive dies or transfer presses.

For producing steel parts with intricate geometries having tensile strengths of greater than about 1400 MPa, hot forming has been developed. Direct hot forming involves heating the steel to elevated temperature, forming the steel at sufficiently high temperature and then cooling the steel in a press. Indirect hot forming involves an additional pre-forming step before heating. Hot forming is also referred to as hot forming and die quenching, press hardening, hot stamping, and hot press forming. The steel used in this process has good formability at high temperature and yet provides exceptionally high strength when cooled at a critical cooling rate from high temperature. Post-forming hardening is a similar technique that involves heat treatment following forming. In these techniques, exceptionally high strength levels are achieved by heating the steel to temperatures at which austenite forms in the microstructure, for example, temperatures in the range of about 850° C. to about 950° C., and cooling the steel from that temperature at a rate equal to or greater than a critical rate so that the austenite transforms to martensite. An example of this technique is disclosed in British Patent 1,490,535 to Norrbottens Järnverk A B, Sweden, entitled “Manufacturing a hardened steel article”, 1977. The steel disclosed in this reference was uncoated so that it was subjected to oxidation upon heating in air and transfer into the hot stamping press. As a result, oxide particles break off from the steel surface and cause die wear. To remove oxide embedded in the part, the part must be shot blasted, pickled, or processed by other measures, which are costly and undesirable.

To protect the steel from oxidation during hot forming various metallic coatings have been proposed. For example, U.S. Pat. No. 6,296,805 to Laurent et al, and Japanese Patent Publication 2007-291441 to Nippon Steel, both disclose an aluminum or aluminum alloy coated steel for hot forming. However, aluminum coatings generally have poor paintability that has to be addressed by prolonged heating time and do not provide galvanic protection of the steel substrate in service. In addition, the aluminum coating is very expensive when compared to zinc coating.

Another example of coated steel for hot forming is disclosed in U.S. Pat. No. 6,564,604 to Kefferstein et al. The steel disclosed in this reference is coated with zinc or zinc alloy. This patent teaches that an alloyed compound forms on the surface when the steel is subjected to elevated temperature during hot forming. The alloyed compound is said to protect against corrosion and steel decarburization, and also provide lubrication during hot forming. However, all intermetallic compounds according to the zinc-iron binary phase diagram have melting points that are generally well below the hot stamping temperatures employed in practice. This reference does not address the problem of loss of zinc that occurs in various ways during hot forming, which deteriorates corrosion resistance of the coating and is potentially an occupational health hazard for unprotected personnel working in the vicinity of the hot forming operation due to zinc exposure.

More recently it has been proposed to provide an oxide layer comprised of zinc oxide on the Fe—Zn alloy layer of galvannealed steel in order to prevent zinc evaporation during hot forming as disclosed in U.S. Pat. No. 7,673,485 to Imai et al. The oxide film serves as a barrier layer to prevent vaporization of zinc in the underlying zinc coating layer. The barrier layer is to be formed prior to the heating stage preceding hot press forming. The iron content of the zinc iron alloy coating is more than 5 percent, which increases the melting point of the alloy coating and helps prevent zinc evaporation. However, a zinc oxide barrier layer does not completely eliminate zinc losses due to zinc fuming or the problems associated with it during hot forming for reasons set forth below.

The suppression of zinc evaporation during hot forming by covering a hot dip galvanized coated steel with a silicone resin film is disclosed in Japanese Patent Publication 2007-06378 to Kobe Steel. However, the application of such resin films requires special equipment and is costly. It is also noted that thermal decomposition and oxidization of silicone resin may impose occupational health concerns due to the presence of organic content in the overlay. An additional limitation is the formation of silica, i.e. silicon dioxide as a result of decomposition and oxidization of the resin material. Silica has high hardness that may increase die wear.

Surface treatments of various types have been applied to zinc coated steel for a number of purposes to improve service at low temperatures and room temperature. Without altering the functionality of the zinc coating, these treatments have been used to improve corrosion resistance, cold formability, paintability, and resistance to handling and fingerprint marks. Examples of such treatments are phosphate coatings and chromate conversion treatments.

Phosphate coatings have been applied over zinc or zinc-iron alloy coated steel for improving press workability at room temperature, paintability and corrosion resistance. A galvanized zinc layer is relatively soft and has a low melting point, which tends to cause the zinc to fuse and stick to dies during press forming. The zinc particles break off during the forming operation, increasing die wear and decreasing corrosion resistance of the zinc coating. A phosphate layer separates the zinc from the dies, preventing sticking and breaking off of zinc particles from the coating. In addition, the phosphate layer tends to be porous and holds oil and other materials such as soap, providing lubrication during the forming operation. A phosphate pretreatment has also been used to improve the paintability of the zinc or zinc-iron surface on galvanized or galvannealed steel. Application of a suitable phosphate overlay to the zinc or zinc-iron surface provides a good base for bonding with the paint. Phosphate pretreatments may be applied on coil prepainting lines and in post fabrication paint processes, for example in automotive body applications. They have also been applied directly on galvanizing lines to provide a product designed for field painting. However, thermal exposure below 600° C., which is below the temperatures required for hot forming, reportedly leads to decomposition, sublimation and complete breakdown in the hydrated phosphate (see for example, B. Zantout and D. R. Gabe, Trans. Inst. Met. Finish. 61 (1983) 88; T. Sugama et al., “Influence of the high temperature treatment of zinc phosphate conversion coatings on the corrosion protection of steel”, J. Mater. Sci., 26 (1991) 1045-1050. Therefore, the advantages of phosphate treatments for room temperature applications are lost after dehydration due to heating.

Phosphate pretreatments have been applied to steel parts after hot forming, in order to provide a base for bonding with paint as disclosed in Japanese patent publications 2007-06378 to Kobe Steel and 2007-291441 to Nippon Steel. As mentioned in paragraph [7] above, the Kobe steel reference discloses a silicone resin coating applied over galvanized steel prior to hot forming. The phosphate coating is applied to the steel after hot forming. The Nippon Steel reference provides a phosphate conversion coating over aluminum coated steel after hot forming. This reference indicates the phosphate treatment could be applied before heating, but since phosphate deteriorates in a heating step and loses corrosion resistance, it is desirable to apply the chemical conversion coating after the hot pressing step, which is carried out at 600° C. to 690° C. The low temperature heating is required in order to control the formation of aluminum intermetallic compounds in the surface of the coating and enable the phosphate conversion coating applied after forming to adhere to the shaped part. The art does not teach that a phosphate coating could be applied to zinc or zinc alloy coated steel prior to hot forming, or that any benefit would be provided by such pretreatment.

Chromate conversion treatments are used on both zinc and aluminum-zinc coated steel sheet to enhance the corrosion resistance through barrier and passivation effects at room temperatures (R. G. Buchheit and A. E. Hughes, ASM Handbook, ASM International, Vol. 13 A, 2003, p. 720-735). Such treatments change the zinc surface to a protective thin film containing complex chromium and metal compounds such as chromium hydroxide, zinc hydroxyl-chromate, and zinc chromate. Chromate passivation films negatively affect phosphate treatment, paintability and spot weldability. Trivalent chromium treatments at heavier coating weights retain some advantages of chromate passivation yet avoid the environmental issues with hexavalent chromium. More expensive, less corrosion resistant chrome-free conversion coatings with heavier coating weights (4 to 6 vs. 1 milligram per square foot) and higher equipment requirements or limitations are also available with both organic and inorganic base that can contain many different ionic species, including molybdates, tungstates, vanadates, titanates, and fluorides. Conventional chromate or chromate-free conversion coatings are always hydrated for applications at room temperatures, and when heated they begin to dehydrate. Once dehydration occurs, the conversion coating does not protect the zinc or zinc alloy coating anymore and white corrosion quickly follows, resulting in short coating life and red rust. Therefore, none of these coatings are designated or practiced for high temperature applications.

### BRIEF SUMMARY OF THE INVENTION

The present invention is of zinc or zinc alloy coated steel for hot forming having an overlay of inorganic material covering the zinc or zinc alloy as well as any zinc oxide that may exist on the surface of the zinc or zinc alloy. In one embodiment, the inorganic materials used to provide the overlay of this invention have a coefficient of thermal expansion greater than the coefficient of thermal expansion of zinc oxide at the temperature required for hot forming. The overlay may have a three-dimensional, finely porous structure at the temperatures required in hot forming. Therefore, the overlay acts to retard or restrict loss of zinc from the coating by providing an additional barrier layer having the required thermal and surface properties, even if cracks form in the aforementioned zinc oxide layer.

Since the coefficient of thermal expansion of zinc oxide and the coefficient of thermal expansion of the inorganic overlay are empirically inversely related to their respective melting points, the inorganic material for the overlay may be selected on the basis of having a melting point significantly lower than the melting point of zinc oxide which is about 1975° C., or lower when in the form of mixture with other oxide. On the other hand, the melting point of the inorganic overlay should be greater than the temperature required for hot forming. Generally the temperature required for hot forming is greater than the A1 temperature of the steel. Preferably, the temperature for hot forming is above the A3 temperature of the steel, which is generally within a range of from about 850° C. to 950° C., in order to obtain the exceptionally high tensile strength levels desired. Therefore, a preferred range of melting point for the inorganic material would be within a range of about 950° C. to about 1975° C., depending on zinc coating and steel substrate compositions. In addition, the inorganic overlay preferably is chosen to possess lower hardness than zinc oxide and thus offer the possibility of decreased die wear in hot forming.

In another embodiment of this invention, a specific class of inorganic materials used to form the overlay, acts to suppress the loss of zinc by providing a barrier layer having a compositional gradient interface with the zinc or zinc alloy coating so as to provide adaptability with the thermal expansion mismatch between the zinc or zinc alloy and the steel at elevated temperatures. The compositional gradient interface forms either when the inorganic overlay is applied to the zinc or zinc alloy coating, or when the inorganic overlay is heated to elevated temperatures. If the compositional gradient interface does not previously exist but forms at very high temperature, the overlay degrades before it can adapt to the high temperature. Because zinc evaporation typically occurs at temperatures above 650° C. and since zinc evaporation may represent the most severe loss of zinc, the inorganic materials preferably have the capability of forming a compositional gradient interface with the zinc or zinc alloy coating below 650° C.

The inorganic material for the overlay may be comprised of phosphate, oxide, nitrate, carbonate, chromate, silicate, molybdate, tungstate, vanadate, titanate, borate, fluoride and mixtures of these materials. Preferably, the overlay comprises inorganic material selected from the group consisting of zinc phosphate, titanium phosphate, manganese phosphate, calcium phosphate, iron phosphate, nickel phosphate, cobalt phosphate, magnesium phosphate, and mixtures thereof. More preferably the overlay comprises inorganic material selected from the group consisting of zinc phosphate, manganese phosphate, iron phosphate and mixtures thereof. The phosphates may include modifications by calcium, manganese or other elements. A pre-treatment of the steel substrate by titanium phosphate or manganese phosphate may be applied prior to application of the overlay. The overlay may be further treated to prevent contamination, for example, by light oiling. Advantageously, the inorganic overlay may be applied to the zinc coated steel on a continuous galvanizing line.

The steel of this invention is preferably capable of developing tensile strength levels of greater than about 1400 MPa due to the formation of a martensitic microstructure upon cooling from the hot forming temperature. Preferably, the steel comprises in weight percent, carbon 0.06 to 0.45, manganese 0.50 to 3.0, phosphorus less than 0.025, sulfur less than 0.025, aluminum 0.015 to 1.80, silicon less than 0.50, chromium less than 3.0, nickel less than 2.0, molybdenum less than 1.0, nitrogen less than 0.02, the balance iron and unavoidable impurities. More preferably, the steel comprises carbon 0.15 to 0.25, manganese 1.0 to 2.5, phosphorus less than 0.025, sulfur less than 0.008, aluminum 0.015 to 0.15, silicon less than 0.35, chromium less than 1.0, molybdenum less than 0.35, nitrogen less than 0.012, the balance iron and unavoidable impurities. The steel may further comprise one or more carbide or nitride forming elements such as niobium of 0.1 weight percent or less, vanadium of 0.2 weight percent or less, and titanium of 0.15 weight percent or less. Most preferably the steel may further comprise boron within a range of 0.0008 to 0.005 weight percent.

### BRIEF DESCRIPTION OF THE DRAWINGS

FIG. 1 is a line drawing comparing the inorganic overlay of this invention with the prior art.

### DESCRIPTION OF THE PREFERRED EMBODIMENT

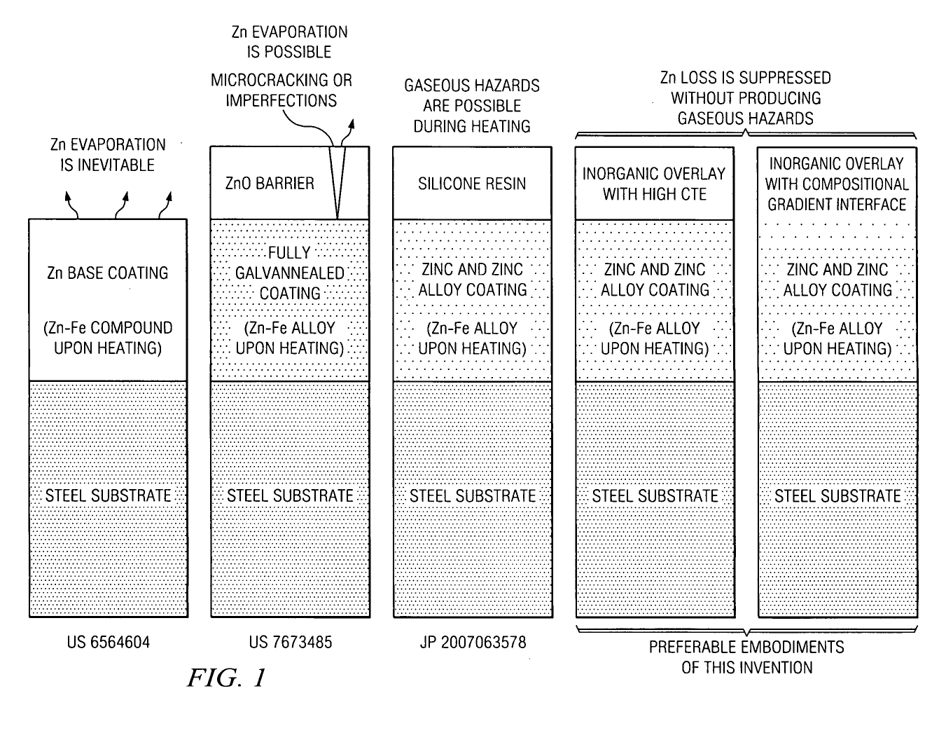

The drawing in FIG. 1 illustrates a comparison of the inorganic overlay of this invention with the zinc coating described in U.S. Pat. No. 6,564,604 to Kefferstein et al., and the zinc oxide layer on the zinc-iron alloy coating described in U.S. Pat. No. 7,673,485 to Imai et al. Kefferstein et al does not disclose any measures to address the evaporation of high vapor pressure zinc at elevated temperatures in hot forming. Imai et al attempts to prevent zinc evaporation by two mechanisms, (i) a zinc oxide barrier layer and (ii) increased melting point of the galvannealed coating with at least 5 weight percent iron. By comparison, the present invention provides two preferred embodiments to suppress the loss of zinc in hot forming with inorganic overlays, one with a hi_{g}h coefficient of thermal expansion, and another with a composition gradient at the interface of the zinc or zinc alloy coating and the overlay.

Investigations conducted in support of the present invention revealed that when steel coated with zinc or zinc alloys is heated to elevated temperature, the zinc oxide layer present on the surface of the coating may become blistered or ruptured. Without wishing to be bound by any specific theory, it is believed that an important cause of oxide layer blistering or rupturing is the expansion of the steel substrate and molten zinc that forms when the steel is heated. Such expansion creates stresses within the zinc oxide which can result in crack formation. Since the zinc oxide layer has a lower coefficient of thermal expansion than solid and liquid zinc and zinc alloys, the zinc oxide does not expand to the same degree as the zinc and zinc alloys, causing microcracks to form in the zinc oxide which eventually ruptures. Even without forming microcracks, the surface oxide layer could rupture due to the degradation of integrity or continuity of the coating when surface imperfections are present, such as dross, debris, roll material, scratches, and abrasions. An undesirable consequence of surface rupture and blistering is the loss of zinc. For example, molten zinc which has high vapor pressure may push through the zinc oxide microcracks to the outer surface. When molten zinc is insufficiently oxidized to seal the microcracks or the vulnerable imperfections, zinc evaporation will occur causing the problems mentioned above.

The present invention provides an inorganic overlay covering the zinc or zinc alloy coating and any zinc oxide that has naturally formed on the surface of the zinc or zinc alloys during and after the zinc coating process. The specific class of inorganic materials used to form the inorganic overlay, acts to suppress the loss of zinc due to surface rupture or cracking at elevated temperature, and help reduce the loss of zinc due to other mechanisms such as zinc extrusion to the surface through the oxide layer during material handling and forming, or due to excessive zinc oxidation at elevated temperatures in hot forming.

In one embodiment of this invention, the inorganic overlay has a coefficient of thermal expansion greater than the coefficient of thermal expansion of zinc oxide at temperatures up to and including the temperature of hot forming. Since the coefficient of thermal expansion of the inorganic coating is greater than that of zinc oxide, the inorganic overlay is better able to adapt to the thermal expansion of the coating during the change of state from solid to liquid and in the liquid when heated for hot forming The inorganic coating may have a three-dimensional, finely porous structure with high surface area, which may originate from the overlay coating process, or result from the dehydration process when heated. The inorganic overlay having the required thermal and surface properties acts to prevent or limit the zinc loss of zinc from the coating during hot forming of the steel, by providing an additional barrier layer even if cracks form in the oxide layer. The inorganic materials used to form the inorganic overlay may in the form of hydrate. However, since the inorganic overlay also serves to improve the integrity and continuity of the coating surface by repairing surface imperfections before hot forming, conventional procedures for treating zinc or zinc alloy coated steel for room temperature applications preferably are modified. For example, in conventional phosphate treatment of zinc or zinc alloy coated steel for room temperature applications, significant amounts of free acid are used in the treatment solution to remove a pre-existing oxide layer. When the phosphate treatment is applied to zinc or zinc alloy coated steel for hot forming, the pre-existing oxide can be retained and vulnerable areas in the oxide and coating can be repaired or sealed. Therefore, the treatment conditions such as free acid content, solution composition, solution temperature, treatment time and drying procedures preferably are selected to provide integrity and continuity of the coating and the overlay. If the overlay is too thin, it may not sufficiently cover the coating; if it is too thick, the treatment may increase costs and negatively impact productivity. Therefore, the specific inorganic overlay of this embodiment has a coating weight of at least 20 milligrams per square foot to 4 grams per square foot. The inorganic overlay may be further treated after application, for example by light chromate coating to prevent contamination or degradation.

Because it is difficult to measure the coefficient of thermal expansion of various inorganic materials, particularly when the inorganic coating has a three-dimensional, finely porous structure, the melting point of the inorganic material may be used as a substitute measure for the coefficient of thermal expansion since the melting point and the coefficient of thermal expansion generally are inversely related. Therefore, an inorganic material with a melting point lower than the melting point of zinc oxide will have a coefficient of thermal expansion greater than the coefficient of thermal expansion of zinc oxide. Pure zinc oxide has a melting point of about 1975° C. The surface oxide on the coating may have a different melting point due to the presence of other elements in the coating that are selectively oxidized when the coating is heated in air. For example, commercial hot dip galvanized coatings always contain aluminum due to aluminum additions to the coating bath. Other elements may be contained in the coating due to coating bath additions and to diffusion of elements from the steel substrate into the coating upon heating to elevated temperature. In conventional hot dip galvanized coatings, the oxide layer may comprise zinc, aluminum, iron and manganese oxides after heating, and thus may have a lower melting point than pure zinc oxide. Therefore, the inorganic overlay preferably should have a melting point significantly lower than 1975° C. in order to have a coefficient of thermal expansion greater than the coefficient of thermal expansion of the oxide. On the other hand the melting point of the inorganic overlay must be greater than the temperature required for hot forming. The temperature required for hot forming is generally within the range of about 850° C. to 950° C. Therefore, the inorganic material should have a melting point within a range of about 950° C. to about 1975° C. or lower, depending on the zinc coating and steel substrate compositions. The melting points of zinc phosphate, titanium phosphate, calcium phosphate and iron phosphate as pure substances are about 900° C., 1500° C., 1391° C. and 1208° C. respectively. The melting point of mixtures of these phosphates may be calculated based on the simple lever rule.

In another embodiment of this invention, a specific class of inorganic materials used to provide the overlay acts to suppress the loss of zinc by providing a barrier layer having a composition gradient at the interface of the overlay and the zinc or zinc alloy coating. By comparison, the oxide layer present on the surface of zinc or zinc alloy coatings forms a structurally sharp interface that has an abrupt composition change. Without wishing to be bound by any specific theory, the abrupt changes of structure and composition at the interface between the zinc oxide and the zinc or zinc alloy coating may not be able to accommodate the overall stress and strain fields created by thermal expansion mismatch between the steel, coating and oxide, and thus the oxide may rupture when the steel is heated to elevated temperatures. The inorganic materials that form a compositional gradient at the interface of the zinc or zinc alloy coating and the inorganic overlay, apparently accommodate the thermal mismatch during heating and thus provide a barrier to prevent the loss of zinc.

The specific inorganic overlay of this embodiment having a compositionally diffuse interface may be similar to one having an outer layer consisting of chromium compounds and zinc chromate and an inner layer appearing to be a transitional region (Z. L. Long et al., Applied Surface Science, Volume 218, Issues 1-4, 2003, pages 124-137). At the indistinct interface, the overlay bulk chromium and oxygen contents decrease from the overlay to the zinc or zinc alloy coating, while zinc content decreases from the coating to the overlay. While dehydration of chromate conversion coatings is detrimental to corrosion resistance at room temperature, the compositional gradient at the interface between a chromate overlay and zinc or zinc alloy coating provides a barrier that can prevent the loss of zinc. Although not wishing to be bound by any specific theory, this structural and compositional transition provides a means for adapting to the thermal expansion mismatch when heating to elevated temperatures and consequently serves to impede zinc losses. The compositional gradient at the interface between the inorganic overlay and zinc or zinc alloy coating of this embodiment forms either when the inorganic overlay is applied to the zinc or zinc alloy coating, or when the inorganic overlay is heated to elevated temperatures. If the compositional gradient at the interface forms too late at elevated temperature, the overlay may not have the required adaptability to thermal expansion mismatch. Therefore, the inorganic materials selected for the overlay preferably have the capability of forming a compositional gradient interface with zinc or zinc alloy coating below 650° C., above which zinc evaporation may be observed in zinc coated steel without the overlay. If the inorganic overlay is too thin, it may not sufficiently cover the coating; if the overlay is too thick, the treatment may not be cost-effective and could cause other production difficulties. Therefore, the specific inorganic overlay of this embodiment has a coating weight of at least 0.5 milligrams per square foot, preferably within a range of from about 0.5 milligrams per square foot to 100 milligrams per square foot.

The inorganic overlay having the capability of developing a compositional gradient interface may be applied to zinc or zinc alloy coated steel which has already been provided with an inorganic overlay having a coefficient of thermal expansion greater than the coefficient of thermal expansion of zinc oxide. This might be particularly applicable where the weight of the pre-existing inorganic overlay is low, for example, less than 50 milligrams per square foot. In this case the inorganic overlay having the capability of developing a compositional gradient interface is used to seal or supplement the pre-existing overlay.

There are a number of inorganic materials that may be used to form the inorganic overlay of this invention. Selection of the particular materials for the inorganic overlay should be based on providing an overall composition for the overlay that has either (i) a coefficient of thermal expansion greater than the coefficient of thermal expansion of zinc oxide, or (ii) a compositional gradient interface with the zinc or zinc alloy coating on the steel. For example, the inorganic material for the overlay may be comprised of material selected from the group consisting of phosphates, oxides, nitrates, carbonates, chromates, silicates, molybdates, tungstates, vanadates, titanates, borates, fluorides and mixtures thereof. More preferably the inorganic material may be comprised of phosphates selected from the group consisting of zinc phosphate, manganese phosphate, calcium phosphate, calcium manganese phosphate, iron phosphate, nickel phosphate, cobalt phosphate, magnesium phosphate, and mixtures thereof. The inorganic material for the overlay also may be comprised of oxides selected from the group consisting of zinc oxide, aluminum oxide, hexavalent chromium oxide, trivalent chromium oxide, molybdenum oxide, titanium oxide, tungsten oxide, vanadium oxide, boron oxide, zinc chromate, zinc molybdate, zinc tungstate, zinc vanadate, zinc titanate, zinc borate, and mixtures thereof. The inorganic material may further comprise modifications by calcium, manganese or other elements. A pre-treatment of the steel substrate may be applied prior to the inorganic overlay, for example, by titanium phosphate or manganese phosphate conditioning. The inorganic materials used to form the inorganic overlay may be applied in the form of a hydrate. And the inorganic overlay may be further treated after application, for example, by chromate coating, to prevent contamination or degradation of the overlay. An overlay containing hexavalent chromium according to this invention may be further converted to non-hexavalent chromium for use in the automotive industry, via heating the subject steel in coil or blank form to 100 to 750° C. for up to 4 hours. Preferably, the conversion may be completed at a temperature of about 300 to 600° C., more preferably at a temperature of 425 to 525° C., for up to 15 minutes. Tto those skilled in the art, it will be apparent that this conversion might be done in conventional batch annealing when the steel is in coil form, or during reheating prior to hot forming when the steel is in blank form.

The zinc or zinc alloy coating may be of various compositions, including without limitation pure zinc, zinc with aluminum up to 0.5%, zinc-iron alloy, zinc-12% nickel alloy, zinc-1% cobalt alloy, 55% aluminum-zinc, zinc-5% aluminum, zinc-chromium alloy, zinc-magnesium alloy, zinc-manganese alloy and other zinc and zinc alloy coatings. Also, the zinc or zinc alloy may be applied by various processes. For example, the coating may be applied by an electrolytic process or it may be applied by hot dip galvanizing, spraying or other means.

A typical hot dip galvanized coating may be comprised of more than 99 weight percent zinc, the balance aluminum and other elements. A typical weight of hot dip galvanized zinc coating would be at least about 0.30 ounce per square foot, known as G30 according to ASTM specifications. The zinc coated steel may be heated to provide a galvannealed coating comprising zinc-iron alloy. For applications at room temperatures, the galvannealed coating has poor paintability when iron is too low, and poor workability due to iron oxidation when the iron content is too high. Therefore, a typical galvannealed zinc-iron alloy coating may have an iron content within a range of from about 8 to about 14 weight percent iron. Both hot dip galvanized and galvannealed coatings may be used in the implementation of this invention.

For certain applications it may be desirable to provide a partially galvannealed coating instead of the typical fully galvannealed coating described above. Fully galvannealed coatings typically exhibit microcracks in the coating. These microcracks tend to increase the likelihood of zinc fuming when the coated material is heated for hot forming. To avoid the presence of microcracks in the as galvannealed coating, a partially galvannealed coating preferably is provided by reheating the zinc coating to an adjusted temperature and time in order to reduce the amount of iron in the zinc coating. The degree of alloying between zinc and iron depends on heating temperature and time. For example, the reheat temperature might be adjusted to a temperature within the range of 465° C. to 550° C. as compared to a temperature within the normal range of 500° C. to 700° C. for conventional galvannealing. The partially galvannealed coating preferably has an iron content within a range of about 0.5 to 5 weight percent iron.

In order to obtain the exceptionally high tensile strength levels required for hot forming various automotive parts, steels that form a martensitic microstructure upon cooling from the hot forming temperature are generally required. Typically, steels capable of achieving at least about 1400 MPa tensile strength are desired. To achieve this level of strength the microstructure should be substantially completely martensitic although a partial martensitic structure may be sufficient for lower strength levels and certain applications. In order to obtain martensite, the steel must be heated to a temperature at which austenite forms in the microstructure. The percentage of austenite formed determines the amount of martensite that can form upon cooling at a critical cooling rate from hot forming temperature. The percentage of austenite formed at various temperatures is related to carbon content and other elements in the steel. For typical steel used in the practice of this invention, the carbon content may be about 0.20 weight percent and the temperature required for complete formation of austenite in such steel is at least about 850° C. Therefore, the temperature that is desired for hot forming is generally within a range of about 850° C. to about 950° C. In order to transform the austenite to martensite, the cooling rate from the hot forming temperature must be greater than a critical cooling rate. The critical cooling rate is generally related to the composition of the steel and for typical steel used in the invention the critical cooling rate is about 20° C. to 40° C. per second, and practically about 30° C. per second. Therefore, cooling must begin at a temperature for the transformation from austenite to ferrite and proceed at an average rate of at least about 30° C. per second to a temperature below about 200° C., in order to substantially completely transform the austenite to martensite. Lower reheating temperature, cooling start temperature, and/or cooling rate may result in the presence of ferrite and/or bainite in the microstructure and thus decrease the final strength. After cooling, further tempering at a temperature of 550° C. maximum maybe applied if higher ductility and/or toughness are desirable.

The steel of this invention is preferably capable of developing tensile strength levels of greater than about 1400 MPa due to the formation of a martensitic microstructure upon cooling from the hot forming temperature. Preferably, the steel comprises in weight percent: carbon 0.06 to 0.45, manganese 0.5 to 3.0, phosphorus less than 0.025, sulfur less than 0.025, aluminum 0.015 to 1.80, silicon less than 0.50, chromium less than 3.0, nickel 2.0, molybdenum less than 1.0 and nitrogen less than 0.020, with the balance being iron and unavoidable impurities. More preferably the steel comprises carbon 0.15 to 0.25, manganese 1.0 to 2.5, phosphorus less than 0.025, sulfur less than 0.008, aluminum 0.015 to 0.15, silicon less than 0.35, chromium less than 1.0, molybdenum less than 0.35, nitrogen less than 0.012, the balance iron and unavoidable impurities. More preferably the steel further comprises one or more of carbide and nitride forming elements such as niobium of 0.1 weight percent of less, vanadium of 0.2 weight percent or less, and titanium of 0.15 weight percent or less. Most preferably, the steel may further comprise boron with a range of 0.0008 to 0.005 weight percent.

The steel of this invention may be pre-formed at room temperature to an initial desired shape and then heated to elevated temperature for hot forming to final shape, or it may be heated without preforming to elevated temperature and hot formed directly to final shape. Heating may be carried out in a gas fired furnace or preferably by induction heating equipment. The temperature for hot forming is selected to be within a range above the A1 temperature of the steel, most preferably the steel is heated above the A3 temperature. For steel of the composition described above, preferably it is heated to a temperature within the range of about 850 to 950° C., for complete austenitization of the microstructure. The heated steel is then hot formed by pressing between dies and the hot formed part is cooled at a rate at least equal to a critical cooling rate to obtain the desired tensile strength in the part. Generally the part is cooled by quenching in the dies of the hot forming equipment. The cooling rate for the example steels should be an average rate of at least 30° C. per second to a temperature below about 200° C. in order to transform austenite in the microstructure to martensite. Alternatively, the steel of this invention may be strengthened by post forming hardening. In this case, the steel is formed to shape at room temperature and then reheated to a temperature above the A1 temperature, preferably above the A3 temperature, and then cooled at a cooling rate greater than the critical cooling rate in order to transform the shaped part to a martensitic microstructure. The inorganic overlay on the zinc or zinc alloy coated steel of this invention, acts to prevent or limit zinc loss or evaporation from the coating during heating for hot forming, as well as heating for post-forming hardening, by providing an additional barrier layer even if cracks form in an oxide layer on the zinc or zinc alloy coating.

Several laboratory tests were performed to compare the effect of thermal cycles simulating hot forming on zinc coated steel having the inorganic overlay of this invention with zinc coated steel that did not have the inorganic overlay. Samples were taken from 1.60 mm thick steel strip that had been hot dip galvanized on a continuous galvanizing line and had coating weight of about 0.60 ounces per square foot according to ASTM G60 specifications. The steel strip had a composition in weight percent of 0.23 carbon, 1.22 manganese, 0.011 phosphorus, 0.005 sulfur, 0.015 silicon, 0.050 copper, 0.017 nickel, 0.004 molybdenum, 0.03 chromium, 0.032 aluminum, 0.005 nitrogen, 0.035 titanium, 0.0018 boron, balance iron and other unavoidable residuals. Some of the samples were fully galvannealed in the laboratory so as to have about 13 weight percent iron in the coating and some were partially galvannealed so as to have a coating with about 4.0 weight percent iron.

In the next step some of the samples were provided with the inorganic overlay of this invention using the immersion method. Some of the samples were treated with PPG CHEMFOS 700 A following the recommended procedure, without the 700B makeup solution which comprises sodium nitrate to provide a zinc phosphate overlay according to this invention. The coating weight of the overlay was about 68 milligrams per square foot. Other samples were given a chromate conversion coating treatment using 0.45 percent potassium dichromate solution. The inorganic overlay of these samples had a coating weight of about 1 milligram per square foot.

Samples with and without the inorganic overlay according to this invention were subjected to a simulated thermal cycle of hot forming by heating at an average rate of about 6° C. per second to 900° C. for 2 minutes and cooled in air to room temperature. The samples were examined visually for coating integrity and continuity and tested for coating adhesion using a Scotch adhesive tape. The results are summarized in Table 1. A Rockwell hardness test was further tested, and all samples have about 113 HRB, which is equivalent to yield strength of 1300 MPa, tensile strength of 1620 MPa and total elongation of 9% in tensile test.

After the simulated thermal cycle of hot forming the coating appearance can be summarized as follows: The galvanized coating is presumably covered with zinc oxide due to oxidation, and has macroscopically and microscopically visible cracks. The fully galvannealed coating has a discolored, yellowish appearance in addition to the presence of zinc oxide deposits in white and blisters, which is believed to be associated with zinc evaporation. The coatings with the inorganic overlay of this invention show insignificant change from the gray appearance and no evidence of zinc evaporation. In the coating adhesion test, the coatings with the inorganic overlay of this invention have good coating adhesion. These tests show that the inorganic overlay of this invention acts to suppress the loss of zinc in the zinc coated steel.

TABLE 1

| | | | | Observation | |
|---|---|---|---|---|---|
| | Zinc | | | after | |
| Sample | Coating | Overlay | Thermal | Thermal | |
| No. | Condition | Type | Treatment | Simulation | Note |
| 1 | Galvanized | None | 900° C./2 | Macroscop- | Comparison |
| | | | minutes | ically and | |
| | | | and air | microscop- | |
| | | | cool | ically visible | |
| | | | | cracks in | |
| | | | | coating sur- | |
| | | | | face | |
| 2 | Fully | None | 900° C./2 | Discoloration | Comparison |
| | Galvannealed | | minutes | from gray to | |
| | With about | | and air | yellow; | |
| | 13% iron | | cool | blisters; zinc | |
| | | | | evaporation | |
| | | | | products in | |
| | | | | white | |
| 3 | Galvanized | Zn | 900° C./2 | No change in | Invention |
| | | phosphate | minutes | gray color; | |
| | | conver- | and air | good coating | |
| | | sion | cool | adhesion; no | |
| | | coating | | evidence of | |
| | | | | Zn | |
| | | | | evaporation | |
| 4 | Galvanized | Chromate | 900° C./2 | No change in | Invention |
| | | conver- | minutes | gray color; | |
| | | sion | and air | good coating | |
| | | coating | cool | adhesion; no | |
| | | | | evidence of | |
| | | | | Zn | |
| | | | | evaporation | |
| 5 | Partially | Chromate | 900° C./2 | No change in | Invention |
| | Galvannealed | conver- | minutes | gray color; | |
| | With about | sion | and air | good coating | |
| | 4% iron | coating | cool | adhesion; no | |
| | | | | evidence of | |
| | | | | Zn | |
| | | | | evaporation | |

What is claimed is:

1. A method of forming steel having a coating comprising zinc or zinc alloy, said method comprising heating the steel to a temperature within a range of temperatures above the A1 temperature of said steel, forming the zinc or zinc alloy coated steel to shape to form a shaped part, said zinc or zinc alloy coated steel having an inorganic overlay covering said zinc or zinc alloy coating prior to heating and forming so as to suppress loss of zinc from the zinc of zinc alloy coating during heating and forming, said inorganic overlay having at least one of (i) a coefficient of thermal expansion greater than the coefficient of thermal expansion of zinc oxide and (ii) a compositional gradient interface with the zinc or zinc alloy coating below 650° C.

2. The method of claim 1 wherein the inorganic overlay has a melting point lower than the melting point of zinc oxide.

3. The method of claim 1 wherein the inorganic overlay comprises material selected from the group consisting of phosphates, oxides, nitrates, carbonates, silicate, chromate, molybdate, tungstate, vanadate, titanate, borate, fluoride and mixtures thereof.

4. The method of claim 1 wherein the inorganic overlay comprises material selected from the group consisting of zinc phosphate, manganese phosphate, calcium phosphate, iron phosphate, nickel phosphate, cobalt phosphate, magnesium phosphate, and mixtures thereof.

5. The method of claim 1 wherein the inorganic overlay comprises material selected from the group consisting of zinc oxide, aluminum oxide, hexavalent chromium oxide, trivalent chromium oxide, molybdenum oxide, titanium oxide, tungsten oxide, vanadium oxide, boron oxide, zinc chromate, zinc molybdate, zinc tungstate zinc vanadate, zinc titanate, zinc borate, and mixtures thereof.

6. The method of claim 1 wherein the zinc or zinc alloy coating comprises at least about 99 weight percent zinc and the inorganic overlay has a weight of at least about 0.1 milligrams per square foot to about 4 grams per square foot.

7. The method of claim 1 wherein the zinc or zinc alloy coating comprises zinc within a range of about 80 to 95 weight percent zinc and iron within a range of 5.0 to 20 weight percent and the inorganic overlay has a weight of at least about 0.1 milligrams per square foot.

8. The method of claim 1 wherein the zinc or zinc alloy coating comprises zinc within a range of about 95 to 99.5 weight percent zinc and iron within a range of about 0.5 to less than 5.0 weight percent and the inorganic overlay has a weight of at least 0.5 milligrams per square foot.

9. The method of claim 1 wherein the inorganic overlay has a weight within a range of 1.0 milligram per square foot to 4 grams per square foot.

10. The method of claim 1 wherein the zinc or zinc alloy coated steel is hot formed at a temperature within said temperature range, said temperature range being from about 700° C. to about 1000° C.

11. The method of claim 1 wherein said zinc or zinc alloy coated steel having said inorganic overlay is pre-formed so as to at least partially form said steel prior to the heating step.

12. The method of claim 1 wherein the shaped part is cooled at a rate greater than a critical cooling rate so as to form a microstructure comprising martensite in said part.

13. The method of claim 1 wherein the steel comprises in weight percent, carbon 0.6 to 0.45, manganese 0.5 to 3.0, phosphorus less than 0.025, sulfur less than 0.025, aluminum 0.015 to 1.80, silicon less than 0.50, chromium less than 3.0, nickel less than 2.0, molybdenum less than 1.0, nitrogen less than 0.020, and optionally one or more of titanium of 0.15 or less, niobium of 0.1 or less, vanadium of 0.2 or less and boron of 0.0008 to 0.005, the balance iron and unavoidable impurities.

14. The method of claim 13 wherein the steel comprises in weight percent, carbon 0.15 to 0.25, manganese 1.0 to 2.5, phosphorus less than 0.025, sulfur less than 0.008, aluminum 0.015 to 0.15, silicon less than 0.35, chromium less than 1.0, molybdenum less than 0.35, nitrogen less than 0.012, and optionally one or more of titanium of 0.15 or less, niobium of 0.1 or less, and vanadium of 0.2 or less and boron of 0.0008 to 0.005, the balance iron and unavoidable impurities.

15. A method of making zinc or zinc alloy coated steel for high strength steel parts, said method comprising providing a steel material having a composition capable of developing tensile strength of at least about 1400 MPa when heated to a temperature greater than the A1 temperature of the steel and cooled at a rate greater than a critical cooling rate so as to form a microstructure comprising martensite, providing a zinc or zinc alloy coating on the steel material, and covering said zinc or zinc alloy coating with an inorganic overlay having at least one of (i) a coefficient of thermal expansion greater than the coefficient of thermal expansion of zinc oxide and (ii) a compositional gradient interface with the zinc or zinc alloy coating below 650° C.

16. The method of claim 15 wherein the inorganic overlay has a melting point lower than the melting point of zinc oxide.

17. The method of claim 15 wherein the inorganic overlay comprises material selected from the group consisting of phosphates, oxides, nitrates, carbonates, silicate, chromate, molybdate, tungstate, vanadate, titanate, borate, fluoride and mixtures thereof.

18. The method of claim 15 wherein the inorganic overlay comprises material selected from the group consisting of zinc phosphate, manganese phosphate, calcium phosphate, iron phosphate, nickel phosphate, cobalt phosphate, magnesium phosphate, and mixtures thereof.

19. The method of claim 15 wherein the inorganic overlay comprises material selected from the group consisting of zinc oxide, aluminum oxide, hexavalent chromium oxide, trivalent chromium oxide, molybdenum oxide, titanium oxide, tungsten oxide, vanadium oxide, boron oxide, zinc chromate, zinc molybdate, zinc tungstate, zinc vanadate, zinc titanate, zinc borate, and mixtures thereof.

20. The method of claim 15 in which the step of covering the zinc or zinc alloy with the inorganic overlay comprises providing the inorganic overlay in a hydration form.

21. The method of claim 15 wherein the zinc or zinc alloy coating comprises at least about 99 weight percent zinc and the inorganic overlay has a weight of at least about 0.1 milligrams per square foot to about 4 grams per square foot.

22. The method of claim 15wherein the zinc or zinc alloy coating comprises zinc within a range of about 80 to 95 weight percent zinc and iron within a range of 5.0 to 20 weight percent and the inorganic overlay has a weight of at least about 0.1 milligrams per square foot.

23. The method of claim 15 wherein the zinc or zinc alloy coating comprises zinc within a range of about 95 to 99.5 weight percent zinc and iron within a range of about 0.5 to less than 5.0 weight percent and the inorganic overlay has a weight of at least 0.5 milligrams per square foot.

24. The method of claim 22 wherein the zinc of zinc alloy coating is provided by hot dip galvanizing and partial galvannealing by reheating to a temperature within a range of about 465° C. to about 650° C.

25. The method of claim 15 wherein the inorganic overlay has a weight within a range of 1.0 milligram per square foot to 4 grams per square foot.

26. The method of claim 15 wherein the steel comprises in weight percent, carbon 0.6 to 0.45, manganese 0.5 to 3.0, phosphorus less than 0.025, sulfur less than 0.025, aluminum 0.015 to 1.80, silicon less than 0.50, chromium less than 3.0, nickel less than 2.0, molybdenum less than 1.0, nitrogen less than 0.020, and optionally one or more of titanium of 0.15 or less, niobium of 0.1 or less, vanadium of 0.2 or less and boron of 0.0008 to 0.005, the balance iron and unavoidable impurities.

27. The method of claim 26 wherein the steel comprises in weight percent, carbon 0.15 to 0.25, manganese 1.0 to 2.5, phosphorus less than 0.025, sulfur less than 0.008, aluminum 0.015 to 0.15, silicon less than 0.35, chromium less than 1.0, molybdenum less than 0.35, nitrogen less than 0.012, and optionally one or more of titanium of 0.15 or less, niobium of 0.1 or less, and vanadium of 0.2 or less and boron of 0.0008 to 0.005, the balance iron and unavoidable impurities.

28. The method of claim 1 wherein the inorganic overlay containing hexavalent chromium is converted to non-hexavalent chromium by heating to a temperature within the range of 100 to 750° C. for up to 4 hours.

29. The method of claim 15 wherein the inorganic overlay containing hexavalent chromium is converted to non-hexavalent chromium by heating to a temperature within the range of 100 to 750° C. for up to 4 hours.
